(19) United States
(12) Patent Application Publication
(10) Pub. No.: US 2024/0128516 A1
(43) Pub. Date: Apr. 18, 2024

(54) ALL-SOLID-STATE SECONDARY BATTERY

(71) Applicant: TDK CORPORATION, Tokyo (JP)

(72) Inventors: Keiko TAKEUCHI, Tokyo (JP); Kazumasa TANAKA, Tokyo (JP); Keitaro OTSUKI, Tokyo (JP)

(73) Assignee: TDK CORPORATION, Tokyo (JP)

(21) Appl. No.: 18/277,663

(22) PCT Filed: Mar. 23, 2022
(86) PCT No.: PCT/JP2022/013369

§ 371 Date: Aug. 17, 2023

(30) Foreign Application Priority Data
Mar. 25, 2021 (JP) 2021-051470

(51) Int. Cl. H01M 10/0585; H01M 10/0525; H01M 10/0562

(52) U.S. Cl. CPC H01M 10/0585; H01M 10/0525; H01M 10/0562; H01M 2004/021

(57) ABSTRACT

An all-solid-state secondary battery includes a laminate which includes a plurality of positive electrode layers each having a positive electrode active material layer, a plurality of negative electrode layers each having a negative electrode active material layer, and a plurality of solid electrolyte layers each containing a solid electrolyte, and wherein the positive and negative electrode layers are alternately laminated with the solid electrolyte layers interposed therebetween, wherein the plurality of solid electrolyte layers includes a first and a second outer solid electrolyte layer disposed on both end portion sides of the laminate in a lamination direction, and an inner solid electrolyte layer disposed between the first and second outer solid electrolyte layers, and both the first and second outer solid electrolyte layers are a thick-film outer solid electrolyte layer having a thickness more than that of the inner solid electrolyte layer.

### TECHNICAL FIELD

The present invention relates to an all-solid-state secondary battery.

Priority is claimed on Japanese Patent Application No. 2021-051470, filed Mar. 25, 2021, the content of which is incorporated herein by reference.

### BACKGROUND ART

In recent years, developments in electronics technology have been remarkable, and portable electronic devices have become smaller and lighter, thinner, and more multifunctional. Along with that, there is a strong demand for batteries serving as power sources of electronic devices to be smaller and lighter, thinner, and more reliable. At present, commonly used lithium-ion secondary batteries have conventionally used an electrolyte (electrolytic solution) such as an organic solvent as a medium for moving ions. However, in the battery of the above-described configuration, there is a likelihood that the electrolytic solution will leak out.

Also, since an organic solvent or the like used in the electrolytic solution is a combustible substance, it is required to further enhance the safety of batteries. Therefore, as one measure for enhancing the safety of batteries, it has been proposed to use a solid electrolyte instead of an electrolytic solution as the electrolyte. Further, development of an all-solid-state secondary battery in which a solid electrolyte is used as the electrolyte and other components are also formed of solids is underway.

It is generally preferable that a solid electrolyte forming an all-solid-state battery be dense, but in this case there is a problem in that cracks occur due to volumetric expansion and contraction of an electrode layer according to charging and discharging reactions of the all-solid-state battery, resulting in short-circuiting.

In response to such a problem, in Patent Document 1, a D50% particle size of crystal grains of a phosphate-based solid electrolyte is made to be 0.5 μm or less, and a D90% particle size of crystal grains is made to be 3 μm or less, thereby improving a surface roughness of a green sheet and suppressing occurrence of short circuit.

### CITATION LIST

### Patent Document

### [Patent Document 1]

Japanese Unexamined Patent Application, First Publication No. 2020-42984

### SUMMARY OF INVENTION

### Technical Problem

However, an effect of suppressing occurrence of cracks due to volumetric expansion and contraction cannot be sufficiently obtained with the method described in Patent Document 1.

An objective of the present invention is to provide an all-solid-state secondary battery having satisfactory short-circuit resistance.

### Solution to Problem

In order to solve the above-described problems, the present invention provides the following means.
(1) An all-solid-state secondary battery according to a first aspect of the present invention includes a laminate which includes a plurality of positive electrode layers each including a positive electrode active material layer, a plurality of negative electrode layers each including a negative electrode active material layer, and a plurality of solid electrolyte layers each containing a solid electrolyte, and in which the positive electrode layers and the negative electrode layers are alternately laminated with the solid electrolyte layers interposed therebetween, in which the plurality of solid electrolyte layers includes a first outer solid electrolyte layer and a second outer solid electrolyte layer disposed on both end portion sides of the laminate in a lamination direction, and an inner solid electrolyte layer (with a thickness of tₐ) disposed between the first outer solid electrolyte layer and the second outer solid electrolyte layer, and at least one outer solid electrolyte layer of the first outer solid electrolyte layer and the second outer solid electrolyte layer is a thick-film outer solid electrolyte layer (with a thickness of t_{bn} (1≤n)>tₐ) having a thickness more than that of the inner solid electrolyte layer.
(2) In the all-solid-state secondary battery according to the above-described aspect, the thick-film outer solid electrolyte layer may include a plurality of solid electrolyte layers, and a layer of the plurality of solid electrolyte layers disposed closer to each of the end portions may have a more thickness.
(3) In the all-solid-state secondary battery according to the above-described aspect, the thick-film outer solid electrolyte layer may include a plurality of solid electrolyte layers, and when a thickness of an n-th thick-film outer solid electrolyte layer in the plurality of solid electrolyte layers counted inward from a thick-film outer solid electrolyte layer disposed at the end portion is t_{bn}, the following expression is satisfied.

t_{b(n+1)}≤t_{bn}≤t_{b(n+1)}×2
(4) In the all-solid-state secondary battery according to the above-described aspect, when the number of layers of the thick-film outer solid electrolyte layer is q, the following expression may be satisfied.

3≤q
(5) In the all-solid-state secondary battery according to the above-described aspect, the solid electrolyte may have a crystal structure of any one of a NaSICON type, a garnet type, and a perovskite type.

### Advantageous Effects of Invention

According to the present invention, it is possible to provide an all-solid-state secondary battery having satisfactory short-circuit resistance.

### BRIEF DESCRIPTION OF DRAWINGS

FIG. 1 is an external view of an all-solid-state secondary battery according to one embodiment of the present invention.

FIG. 2 is an external view of a laminate according to one embodiment of the present invention.

FIG. 3 is a schematic cross-sectional view of an example of an all-solid-state secondary battery according to a first embodiment of the present invention.

FIG. 4 is a schematic cross-sectional view of another example of an all-solid-state secondary battery according to a second embodiment of the present invention.

### DESCRIPTION OF EMBODIMENTS

Hereinafter, one embodiment of the present invention will be described in detail with reference to the drawings as appropriate. In the drawings used in the following description, there are cases in which illustration is simplified for convenience so that characteristics of the present embodiment can be easily understood, and dimensional ratios or the like of each of components may be different from actual ones. Materials, dimensions, and the like exemplified in the following description are merely examples, and the present embodiment is not limited thereto and can be implemented with appropriate modifications within a range in which the effects of the present invention are achieved. For example, configurations described in different embodiments can be appropriately combined and implemented.

As all-solid-state secondary batteries, an all-solid-state lithium ion secondary battery, an all-solid-state sodium ion secondary battery, an all-solid-state magnesium ion secondary battery, and the like can be mentioned. Hereinafter, an all-solid-state lithium ion secondary battery will be described as an example, but the present invention is generally applicable to any all-solid-state secondary battery.

### All-Solid-State Secondary Battery (First Embodiment)

An all-solid-state secondary battery includes a laminate having a first electrode layer, a second electrode layer, and a solid electrolyte layer. Either one of the first electrode layer and the second electrode layer functions as a positive electrode, and the other functions as a negative electrode. Hereinafter, for ease of understanding, the first electrode layer will be described as a positive electrode layer, and the second electrode layer will be described as a negative electrode layer.

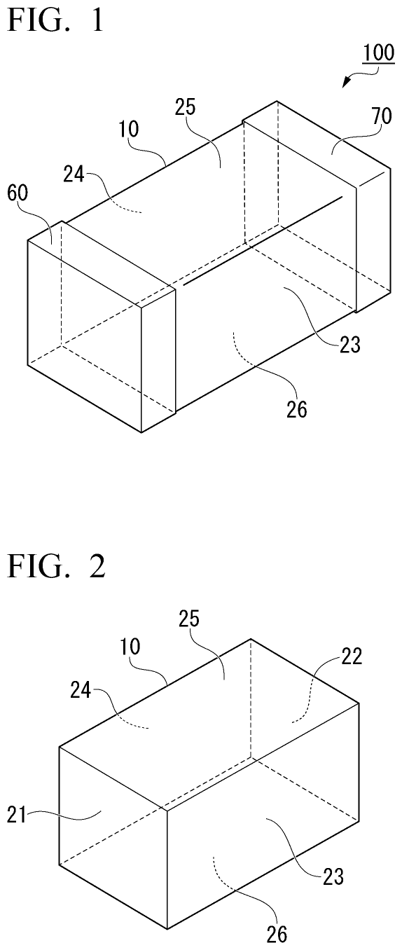

An all-solid-state secondary battery of the present embodiment will be described with reference to FIGS. 1 to 3.

As illustrated in FIG. 1, an all-solid-state secondary battery 100 of a first embodiment includes a laminate 10, an outer positive electrode 60, and an outer negative electrode 70. As illustrated in FIG. 2, the laminate 10 is a hexahedron, and has four side surfaces including a side surface 21, a side surface 22, a side surface 23, and a side surface 24, an upper surface 25, and a lower surface 26. Further, the outer positive electrode 60 and the outer negative electrode 70 are formed on any pair of facing side surfaces. Further, in the embodiment of the all-solid-state secondary battery 100 of FIG. 1, the outer positive electrode 60 is formed on the side surface 21 and the outer negative electrode 70 is formed on the side surface 22 in the laminate 10 of FIG. 2.

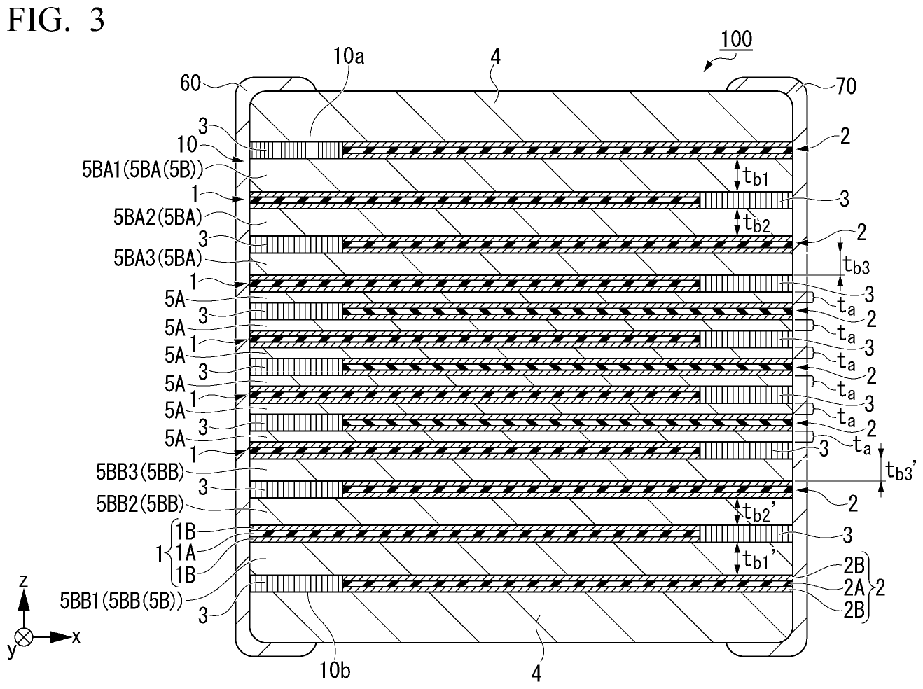

Next, the all-solid-state secondary battery 100 of the present embodiment will be described with reference to the cross-sectional view of FIG. 3. In FIG. 3, L-L is a line indicating a center (middle) position of the laminate 10 in a lamination direction (z direction).

The all-solid-state secondary battery 100 includes the laminate 10 in which a plurality of positive electrode layers 1 each having a positive electrode current collector layer 1A, a positive electrode active material layer 1B, and a side margin layer 3, and a plurality of negative electrode layers 2 each having a negative electrode current collector layer 2A, a negative electrode active material layer 2B, and the side margin layer 3 are alternately laminated with solid electrolyte layers 5 interposed therebetween.

A plurality of solid electrolyte layers 5 includes a first outer solid electrolyte layer 5BA and a second outer solid electrolyte layer 5BB disposed on both end portions 10a and 10b (an upper surface 25 side and a lower surface 26 side) in the lamination direction (z direction) of the laminate 10, and an inner solid electrolyte layer 5A (with a thickness of tₐ) disposed between the first outer solid electrolyte layer 5BA and the second outer solid electrolyte layer 5BA, and in which both the first outer solid electrolyte layer 5BA and the second outer solid electrolyte layer 5BB are each a thick-film outer solid electrolyte layer 5B (with a thickness of t_{bn} (1≤n)>tₐ) having a thickness more than that of the inner solid electrolyte layer 5A. That is, it is preferable that the thickness t_{bn} of at least one of the outer solid electrolyte layers be more than the thickness t a of the inner solid electrolyte layer, and be 1.2 times or more the thickness t a. Also, there is no upper limit to the thickness t_{bn} of the outer solid electrolyte layer, but it is practically assumed to be twice or less the thickness of the inner solid electrolyte layer.

Here, the “solid electrolyte layer” in the “plurality of solid electrolyte layers” refers to one interposed between the positive electrode layer and the negative electrode layer. Therefore, an “outer layer (reference sign 4 in FIG. 3)” to be described later is not included in the “solid electrolyte layer” of the “plurality of solid electrolyte layers.” Among the plurality of solid electrolyte layers 5, the first outer solid electrolyte layer 5BA and the second outer solid electrolyte layer 5BA refer to one or more solid electrolyte layers disposed on an outermost side on a +z side and an outermost side on a −z side in the lamination direction (z direction) of the laminate 10.

The all-solid-state secondary battery 100 illustrated in FIG. 3 includes the outer layer 4 on each outer side of the laminate 10. In the all-solid-state secondary battery 100 illustrated in FIG. 3, the outer layers 4 on both outer sides of the laminate 10 have the same thickness, but may have different thicknesses.

During charging and discharging, the active material layer expands and contracts due to charging and discharging reactions. Accordingly, the entire laminate including the solid electrolyte layers expands and contracts. Particular, when a degree of expansion and contraction differs between layers adjacent to or close to each other, a stress is generated and cracks are likely to occur. In an inner portion (inside) of the laminate, the electrode layers and the solid electrolyte layers are regularly disposed, and the layers are each in substantially an equivalent environment, whereas in the vicinity of end portions of the laminate, a stress is concentrated due to a difference in expansion and contraction from a surrounding environment (wiring substrate, or the like) in which expansion and contraction do not occur, and therefore cracks are likely to occur. Also, even with a configuration in which the outer layers 4 are provided on the outside of the laminate, since the outer layers 4 do not have an active material layer and do not expand or contract, similarly, a stress is concentrated due to a difference in expansion and contraction in the vicinity of the end portions of the laminate, and therefore cracks are likely to occur. Therefore, in the all-solid-state secondary battery of the present invention, the solid electrolyte layers disposed at end portions of the laminate are configured to have a thickness more than that of the solid electrolyte layers disposed in an inner portion, and thereby an amount of expansion and contraction of the solid electrolyte layers is reduced and stress concentration is relieved.

In the present specification, the “thick-film outer solid electrolyte layer” may be one layer or a plurality of layers, but the solid electrolyte layers forming the “thick-film outer solid electrolyte layer” are all required to be thicker than the “inner solid electrolyte layer”. Further, the “inner solid electrolyte layers” all have the same thickness tₐ.

In the all-solid-state secondary battery 100 illustrated in FIG. 3, the first outer solid electrolyte layer 513A and the second outer solid electrolyte layer 5BB, which are the thick-film outer solid electrolyte layer 5B, include a plurality of solid electrolyte layers of 5BA1, 5BA2, 5BA3, 5BB1, 5BB2, and 5BB3, and a solid electrolyte layer of the three solid electrolyte layers of 5BA1, 5BA2, and 5BA3 and a solid electrolyte layer of the three solid electrolyte layers of 5BB1, 5BB2, and 5BB3 disposed closer to the end portions 10a and 10b have a more thickness. That is, thicknesses t_{b1}, t_{b2}, and t_{b3} of the solid electrolyte layers 5BA1, 5BA2, and 5BA3 have a relationship of t_{b1}>t_{b2}>t_{b3}, and similarly, thicknesses t_{b1′}, t_{b2′}, and t_{b3′} of the solid electrolyte layers 5BB1, 5BB2, and 5BB3 have a relationship of t_{b1′}>t_{b2′}>t_{b3′}.

In the plurality of solid electrolyte layers constituting the thick-film outer solid electrolyte layer 5B, a configuration in which thicknesses of the solid electrolyte layers gradually increase toward the end portions 10a and 10b has a superior effect of relieving stress concentration.

In the all-solid-state secondary battery 100 illustrated in FIG. 3, the first outer solid electrolyte layer 513A and the second outer solid electrolyte layer 5BB, which are the thick-film outer solid electrolyte layer 5B, are each constituted by three layers, but the number of layers may be one or other than three.

Also, the number of layers of the first outer solid electrolyte layer 5BA and the number of layers of the second outer solid electrolyte layer 5BB may be different.

In the all-solid-state secondary battery 100 illustrated in FIG. 3, the first outer solid electrolyte layer 5BA and the second outer solid electrolyte layer 5BB, which are the thick-film outer solid electrolyte layer 5B, include a plurality of solid electrolyte layers of 5BA1, 5BA2, 5BA3, 5BB1, 5BB2, and 5BB3, and when thicknesses of n-th thick-film outer solid electrolyte layers among the plurality of solid electrolyte layers 5BA1, 5BA2, 5BA3, 5BB1, 5BB2, and 5BB3 counted inward from thick-film outer solid electrolyte layers disposed at the end portions 10a and 10b are t_{bn} and t_{bn′}, respectively, it is preferable to have the following relationship.

t_{b(n+1)}≤t_{bn}≤t_{b(n+1)}×2

t_{b(n+1)′}≤t_{bn′}≤t_{b(n+1)′}×2

The inequality sign on the left side indicates that an inner solid electrolyte layer disposed on the end portion side has a thickness equal to or more than a thickness of an inner solid electrolyte layer disposed inward thereof. The inequality sign on the right side indicates that an inner solid electrolyte layer disposed on the end portion side has a thickness smaller than twice a thickness of an inner solid electrolyte layer disposed inward thereof.

Here, the thick-film outer solid electrolyte layer disposed at the end portion 10a in the lamination direction is assumed to be a first thick-film outer solid electrolyte layer from the end portion 10a side, and a thickness thereof is assumed to be t_{b1}. The thick-film outer solid electrolyte layer disposed at the end portion 10b in the lamination direction is assumed to be a first thick-film outer solid electrolyte layer from the end portion 10b side, and a thickness thereof is assumed to be t_{b1′}.

If a difference in thickness between the plurality of solid electrolyte layers constituting the thick-film outer solid electrolyte layer 5B and the solid electrolyte layer adjacent thereto becomes too large, the effect of relieving stress concentration is weakened, and therefore a smaller difference and a continuous change in thickness increase the relieving effect.

### All-Solid-State Secondary Battery (Second Embodiment)

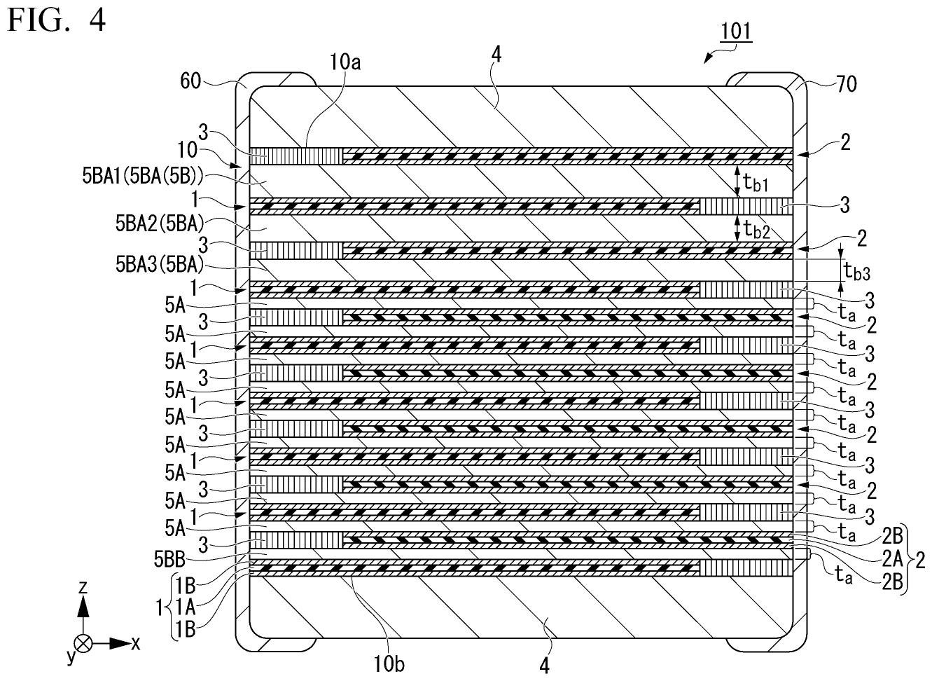

The all-solid-state secondary battery 100 according to the first embodiment illustrated in FIG. 3 is an example of a configuration in which both the first outer solid electrolyte layer 5BA and the second outer solid electrolyte layer 5BB are the thick-film outer solid electrolyte layer 5B having a thickness more than that of the inner solid electrolyte layer 5A, but an all-solid-state secondary battery 101 according to a second embodiment illustrated in FIG. 4 is an example of a configuration in which, of the first outer solid electrolyte layer 5BA and the second outer solid electrolyte layer 5BB, only one of the first outer solid electrolyte layers 5BA is the thick-film outer solid electrolyte layer 5B having a thickness more than that of the inner solid electrolyte layer 5A. In this case, only a solid electrolyte layer closest to the end portion 10b is the second outer solid electrolyte layer 5BB, and a solid electrolyte layer on an inward side thereof is the inner solid electrolyte layer 5A.

When the number of thick-film outer solid electrolyte layers is q,

3≤q

is preferably satisfied.

When the number of thick-film outer solid electrolyte layers is three or more, the effect of relieving stress concentration is superior.

The thick-film outer solid electrolyte layer and the inner solid electrolyte layer preferably contain solid electrolytes having the same crystal structure.

A solid electrolyte constituting the thick-film outer solid electrolyte layer and the inner solid electrolyte layer preferably has a crystal structure of any one of a NaSICON type, a garnet type, and a perovskite type exhibiting high ionic conductivities.

When the thick-film outer solid electrolyte layer and the inner solid electrolyte layer contain solid electrolytes having the same crystal structure, since the ionic conductivities are the same, charging and discharging reactions on both sides occur uniformly. Therefore, since a stress load due to volume expansion is uniformly generated on both sides, cracks inside the laminate are suppressed, and short-circuit resistance required for a battery is improved.

Hereinafter, each layer constituting the all-solid-state secondary battery according to the present embodiment will be described in detail.

Further, as a description in the following, either one or both of the positive electrode active material and the negative electrode active material may be collectively referred to as an active material, either one or both of the positive electrode current collector layer and the negative electrode current collector layer may be collectively referred to as a current collector layer, either one or both of the positive electrode active material layer and the negative electrode active material layer may be collectively referred to as an active material layer, either one or both of the positive electrode and the negative electrode may be collectively referred to as an electrode, and either one or both of the outer positive electrode and the outer negative electrode may be collectively referred to as an outer electrode.

### (Solid Electrolyte Layer)

The solid electrolyte layer (the first outer solid electrolyte layer, the second outer solid electrolyte layer, and the inner solid electrolyte layer) is not particularly limited, and may include a solid electrolyte having a crystal structure of any one selected from the group consisting of, for example, a NaSICON-type, a garnet-type, a perovskite-type, and a LiSICON-type crystal structures. For example, a general solid electrolyte material such as an oxide-based lithium ion conductor having a crystal structure of a NaSICON type, a garnet type, a perovskite type, and a LiSICON type can be used. As the solid electrolyte material, at least one type of an ion conductor (for example, Li₁₊ₓAlₓTi₂₋ₓ(PO₄)₃; LATP) having a NaSICON-type crystal structure containing at least Li (lithium), M (M is at least one of Ti (titanium), Zr (zirconium), Ge (germanium), Hf (hafnium), and Sn (tin)), P (phosphorus), and O (oxygen), an ion conductor (for example, Li₇La₃Zr₂O₁₂; LLZ) having a garnet-type crystal structure containing at least Li (lithium), Zr (zirconium), La (lanthanum), and O (oxygen) or an ion conductor having a garnet-type similar structure, an ion conductor (for example, Li₃ₓLa_{2/3-x}TiO₃; LLTO) having a perovskite-type structure containing at least Li (lithium), Ti (titanium), La (lanthanum), and O (oxygen), and a lithium ion conductor (for example, Li_{3.5}Si_{0.5}P_{0.5}O_{3.5}:LSPO) having a LiSICON-type crystal structure containing at least Li, Si, P, and O can be mentioned. That is, one type of these ion conductors may be used, or two or more types thereof may be used in combination.

As the solid electrolyte material of the present embodiment, it is preferable to use a lithium ion conductor having a NaSICON-type crystal structure, and is preferable to include a solid electrolyte material represented by, for example, Li₁₊ₓAlₓTi₂₋ₓ(PO₄)₃ (LATP, 0<x≤0.6)), LiZr₂(PO₄)₃ (LZP), LiTi₂(PO₄)₃ (LTP), Li₁₊ₓAlₓGe₂₋ₓ(PO₄)₃ (LAGP, 0<x≤0.6), and Li₁₊ₓYₓZr₂₋ₓ(PO₄)₃ (LYZP, 0<x≤0.6).

### (Positive Electrode Layer and Negative Electrode Layer)

For example, a plurality of positive electrode layers 1 and a plurality of negative electrode layers 2 are provided in the laminate 10, and face each other with a solid electrolyte layer interposed therebetween.

The positive electrode layer 1 includes the positive electrode current collector layer 1A, the positive electrode active material layer 1B, and the side margin layer 3. The negative electrode layer 2 includes the negative electrode current collector layer 2A and the negative electrode active material layer 2B.

### (Positive Electrode Active Material Layer and Negative Electrode Active Material Layer)

The positive electrode active material layer 1B and the negative electrode active material layer 2B according to the present embodiment contain known materials at least capable of absorbing and desorbing lithium ions as a positive electrode active material and the negative electrode active material. In addition, a conductive auxiliary agent and an ion-conductive auxiliary agent may be contained. It is preferable that the positive electrode active material and the negative electrode active material can efficiently absorb and desorb lithium ions. Thicknesses of the positive electrode active material layer 1B and the negative electrode active material layer 2B are not particularly limited, but can be in a range of 0.5 μm or more and 5.0 μm or less as an example of a guideline.

As the positive electrode active material and the negative electrode active material, for example, a transition metal oxide and a transition metal composite oxide can be mentioned. Specific examples of the positive electrode active material and the negative electrode active material include, for example, lithium manganese composite oxide Li₂MnₐMa₁₋ₐO₃ (0.8≤a≤1, Ma=Co, Ni), lithium cobalt oxide (LiCoO₂), lithium nickel oxide (LiNiO₂), lithium manganese spinel (LiMn₂O₄), a composite metal oxide represented by a general expression: LiNiₓCo_{y}Mn_{z}O₂ (x+y+z=1, 0≤x≤1, 0≤y≤1, 0≤z≤1), a lithium vanadium compound (LiV₂O₅), olivine type LiMbPO₄ (in which, Mb represents one or more elements selected from Co (cobalt), Ni (nickel), Mn (manganese), Fe (iron), Mg (magnesium), Nb (niobium), Ti (titanium), Al (aluminum), and Zr (zirconium)), lithium vanadium phosphate (Li₃V₂(PO₄)₃ or LiVOPO₄), Li-excess solid solution positive electrode represented by Li₂MnO₃-LiMcO₂ (Mc=Mn, Co, Ni), lithium titanate (LiaTi₅O₁₂), titanium oxide (TiO₂), a composite metal oxide represented by LiₛNiₜCoᵤAlᵥO₂ (0.9<s<1.3, 0.9<t+u+v<1.1), and the like.

The positive electrode active material and the negative electrode active material of the present embodiment preferably contain a phosphoric acid compound as a main component, and are preferably one or more of, for example, olivine type LiMbPO₄ (in which, Mb represents one or more elements selected from Co, Ni, Mn, Fe, Mg, Nb, Ti, Al, and Zr), lithium vanadium phosphate (LiVOPO₄, Li₃V₂(PO₄)₃, or Li₄(VO)(PO₄)₂), and lithium vanadium pyrophosphate (Li₂VOP₂O₇, Li₂VP₂O₇, or Li₉V₃(P₂O₇)₃(PO₄)₂).

Also, as the negative electrode active material, for example, an Li metal, an Li—Al alloy, an Li—In alloy, carbon, silicon (Si), a silicon oxide (SiOₓ), lithium titanate (Li₄Ti₅O₁₂), and a titanium oxide (TiO₂) can be used.

Here, there is no clear distinction between the active materials forming the positive electrode active material layer 1B and the negative electrode active material layer 2B, and when potentials of two types of compounds, that is, a compound in the positive electrode active material layer and a compound in the negative electrode active material layer, are compared, a compound exhibiting a higher potential can be used as the positive electrode active material, and a compound exhibiting a lower potential can be used as the negative electrode active material. Also, as long as it is a compound having functions of absorbing and desorbing lithium ions at the same time, the same material may be used as the material forming the positive electrode active material layer 1B and the negative electrode active material layer 2B.

As the conductive auxiliary agent, carbon materials such as carbon black, acetylene black, Ketjen black, carbon nanotubes, graphite, graphene, and activated carbon, and metal materials such as gold, silver, palladium, platinum, copper, and tin can be mentioned.

The ion-conductive auxiliary agent is, for example, a solid electrolyte. As the solid electrolyte, specifically, the same material as the material used for, for example, the solid electrolyte layers 5A and 5B can be used.

When a solid electrolyte is used as the ion-conductive auxiliary agent, it is preferable that the ion-conductive auxiliary agent use the same material as the first outer solid electrolyte layer, the second outer solid electrolyte layer, and the inner solid electrolyte layer.

### (Positive Electrode Current Collector and Negative Electrode Current Collector)

As materials forming the positive electrode current collector layer 1A and the negative electrode current collector layer 2A, it is preferable to use materials having high conductivity and, for example, silver, palladium, gold, platinum, aluminum, copper, nickel, and the like are preferably used. Particularly, copper is more preferable because it does not easily react with an oxide-based lithium ion conductor, and furthermore, has an effect of reducing an internal resistance of the all-solid-state secondary battery. As the materials forming the positive electrode current collector layer 1A and the negative electrode current collector layer 2A, the same material may be used or different materials may be used. Thicknesses of the positive electrode current collector 1A and the negative electrode current collector 2A are not particularly limited, but can be in a range of 0.5 μm or more and 30 μm or less as an example of a guideline.

Also, it is preferable that the positive electrode current collector layer 1A and the negative electrode current collector layer 2A contain a positive electrode active material and a negative electrode active material, respectively.

When the positive electrode current collector layer 1A and the negative electrode current collector layer 2A respectively contain the positive electrode active material and the negative electrode active material, this is desirable because adhesions between the positive electrode current collector layer 1A and the positive electrode active material layer 1B and between the negative electrode current collector layer 2A and the negative electrode active material layer 2B are improved.

Proportions of the positive electrode active material and the negative electrode active material in the positive electrode current collector layer 1A and the negative electrode current collector layer 2A of the present embodiment are not particularly limited as long as the current collectors perform their own functions, but a volume ratio between the positive electrode current collector and the positive electrode active material, or the negative electrode current collector and the negative electrode active material is preferably in a range of 90/10 to 70/30.

### (Side Margin Layer)

The side margin layer 3 is preferably provided to eliminate a step between the solid electrolyte layer and the positive electrode layer 1 and a step between the solid electrolyte layer and the negative electrode layer 2. Therefore, the side margin layer 3 indicates a region other than the positive electrode layer 1. Since the steps between the solid electrolyte layer, and the positive electrode layer 1 and the negative electrode layer 2 are eliminated due to the presence of the side margin layers 3, denseness of the electrodes is increased, and delamination and warpage due to calcination of the all-solid-state secondary battery do not easily occur.

A material forming the side margin layer 3 preferably contains, for example, the same material as the solid electrolyte layer. Therefore, the material forming the side margin layer 3 preferably contains an oxide-based lithium ion conductor having a crystal structure of a NaSICON type, a garnet type, or a perovskite type. As the lithium ion conductor having a NaSICON-type crystal structure, at least one type of an ion conductor having a NaSICON-type crystal structure containing at least Li, M (M is at least one of Ti (titanium), Zr (zirconium), Ge (germanium), Hf (hafnium), and Sn (tin)), P, and O, an ion conductor having a garnet-type crystal structure containing at least Li, Zr, La, and O, or a garnet-type similar structure, and an ion conductor having a perovskite-type structure containing at least Li, Ti, La, and O can be mentioned. That is, one type of these ion conductors may be used, or a plurality of types thereof may be used in combination. According to the all-solid-state secondary battery of the present embodiment, it is possible to suppress occurrence of cracks and improve short-circuit resistance.

### (Outer Layer)

The outer layer 4 is disposed on either one or both (both in FIG. 3) of regions on an outer side than either of the positive electrode layer 1 (the positive electrode current collector layer 1A) and the negative electrode layer 2 (the negative electrode current collector layer 2A) in a lamination direction. For the outer layer 4, the same material as the solid electrolyte layer may be used. Further, in the present embodiment, the lamination direction corresponds to the z direction in FIG. 3.

A thickness of the outer layer 4 is not particularly limited, but may be, for example, 20 μm or more and 100 μm or less. When the thickness is 20 μm or more, the all-solid-state secondary battery has a high capacity because the positive electrode layer 1 or the negative electrode layer 2 closest to a surface of the laminate 10 in the lamination direction is less likely to be oxidized due to an influence of the atmosphere in a calcination process, and has high reliability because sufficient humidity resistance is secured even in an environment such as a high temperature and high humidity. Also, when the thickness is 100 μm or less, the all-solid-state secondary battery has a high volumetric energy density.

(Method of Manufacturing all-Solid-State Secondary Battery)

The all-solid-state secondary battery of the present invention can be manufactured by the following procedure. A simultaneous calcination method may be used or a sequential calcination method may be used. The simultaneous calcination method is a method of making a laminate by laminating materials forming each layer and then collectively calcining them. The sequential calcination method is a method in which each layer is made in sequence and a calcination step is performed each time each layer is made. Use of the simultaneous calcination method can reduce the number of work steps of the all-solid-state secondary battery. Also, use of the simultaneous calcination method makes the obtained laminate dense. A case of using the simultaneous calcination method will be described below as an example.

The simultaneous calcination method includes a step of preparing a paste of each material constituting the laminate, a step of applying and drying the pastes to prepare green sheets, and a step of laminating the green sheets and simultaneously calcining the prepared laminate.

First, materials of the positive electrode current collector layer 1A, the positive electrode active material layer 1B, the inner solid electrolyte layer 5A, the first outer solid electrolyte layer 5BA, the second outer solid electrolyte layer 5BB, the negative electrode current collector layer 2A, the negative electrode active material layer 2B, and the side margin layer 3 are each made into a paste. The method of making a paste is not particularly limited, but for example, a paste can be obtained by mixing a powder of each material with a vehicle. Here, the vehicle refers to a generic name for a medium in a liquid phase, and includes a solvent, a binder, and the like. A binder contained in the paste for forming a green sheet or a printing layer is not particularly limited, but a polyvinyl acetal resin, a cellulose resin, an acrylic resin, an urethane resin, a vinyl acetate resin, a polyvinyl alcohol resin, or the like can be used, and a slurry thereof can contain at least one of these resins.

Also, the paste may contain a plasticizer. Types of the plasticizer are not particularly limited, but phthalate esters such as dioctyl phthalate and diisononyl phthalate, or the like may be utilized.

By such a method, a positive electrode current collector layer paste, a positive electrode active material layer paste, a solid electrolyte layer paste, a negative electrode active material layer paste, a negative electrode current collector layer paste, and a side margin layer paste are made.

Next, a green sheet is made. The green sheet is obtained by applying the prepared paste onto a base material such as polyethylene terephthalate (PET) in a desired order, drying it if necessary, and peeling off the base material. A method of applying the paste is not particularly limited. For example, known methods such as screen printing, coating, transfer, and doctor blade can be employed.

The prepared solid electrolyte layer paste is applied on a substrate such as polyethylene terephthalate (PET) to a desired thickness and is dried as necessary to prepare a green sheet for a solid electrolyte (inner solid electrolyte layer). Also for the first outer solid electrolyte layer and the second outer solid electrolyte layer, a green sheet for a solid electrolyte (the first outer solid electrolyte layer) and a green sheet for a solid electrolyte (the second outer solid electrolyte layer) are made by the same procedure. At least one of the first outer solid electrolyte layer and the second outer solid electrolyte layer is the thick-film outer solid electrolyte layer having a thickness more than that of the inner solid electrolyte layer.

A method of making the green sheet for a solid electrolyte is not particularly limited, and known methods such as a doctor blade method, a die coater, a comma coater, and a gravure coater can be employed.

Next, the positive electrode active material layer 1B, the positive electrode current collector layer 1A, and the positive electrode active material layer 1B are printed and laminated in that order on the green sheet for a solid electrolyte by screen printing to form the positive electrode layer 1. Further, in order to fill a step between the green sheet for a solid electrolyte and the positive electrode layer 1, the side margin layer 3 is formed in a region other than the positive electrode layer 1 by screen printing to make a positive electrode unit (one in which the positive electrode layer 1 and the side margin layer 3 are formed on the solid electrolyte layer). The positive electrode unit is made for each of the thick-film outer solid electrolyte layer and the inner solid electrolyte layer.

The negative electrode unit can also be made by the same method as the positive electrode unit.

Then, the positive electrode unit and the negative electrode unit are laminated to a predetermined number of layers while being alternately offset so that one end of the positive electrode and one end of the negative electrode are not aligned, and thereby a laminated substrate formed of elements of an all-solid-state secondary battery is made. Further, outer layers can be provided on the laminated substrate on both main surfaces of the laminate as necessary. The same material as the solid electrolyte layer can be used for the outer layers, and for example, the green sheet for a solid electrolyte can be used. Also, the first outer solid electrolyte layer and the second outer solid electrolyte layer may have only one layer, or may have a plurality of layers (at a plurality of positions).

The manufacturing method described above is for manufacturing an all-solid-state secondary battery of a parallel type, and in a manufacturing method for an all-solid-state secondary battery of a series type, lamination may be made so that one end of the positive electrode and one end of the negative electrode are aligned, that is, without them being offset.

Further, the manufactured laminated substrate can be collectively pressed by a die press, a warm isostatic press (WIP), a cold isostatic press (CIP), an isostatic press, or the like to improve the adhesion. Pressurization is preferably performed while heating, and can be performed at, for example, 40 to 95° C.

The manufactured laminated substrate can be cut into laminates of uncalcined all-solid-state secondary batteries using a dicing device.

The laminate is sintered by debinding and calcining the laminate of the all-solid-state secondary battery. In the debinding and calcination, the calcination can be performed at a temperature of 600° C. to 1000° C. in a nitrogen atmosphere. A retention time for the debinding and calcination is, for example, 0.1 to 6 hours.

Barrel polishing is performed by chamfering corners of the laminate for the purpose of preventing chipping and for exposing an end surface of the current collector layer. The barrel polishing may be performed on the laminate 10 of the uncalcined all-solid-state secondary battery, or may be performed on the laminate 10 after calcination. Barrel polishing methods include dry barrel polishing without using water and wet barrel polishing with water. When wet barrel polishing is performed, an aqueous solution such as water is separately supplied to a barrel polishing machine.

Conditions for barrel processing are not particularly limited, can be adjusted as appropriate, and may be performed within a range in which defects such as cracking and chipping do not occur in the laminate.

Further, outer electrodes (the outer positive electrode 60 and the outer negative electrode 70) can be provided to efficiently draw a current from the laminate 10 of the all-solid-state secondary battery. The outer electrodes are configured so that the outer positive electrode 60 and the outer negative electrode 70 are formed on a pair of facing side surface 21 and side surface 22 of the laminate 10. As a method of forming the outer electrode, a sputtering method, a screen printing method, a dip coating method, or the like can be mentioned. In the screen printing method and the dip coating method, an outer electrode paste containing a metal powder, a resin, and a solvent is made to be formed as an outer electrode. Next, a baking process for removing the solvent and a plating treatment for forming a terminal electrode on a surface of the outer electrode are performed. On the other hand, since the outer electrode and the terminal electrode can be directly formed by the sputtering method, a baking process and a plating treatment are not required.

The laminate 10 of the all-solid-state secondary battery described above may be sealed in, for example, a coin cell to enhance humidity resistance and impact resistance. A sealing method thereof is not particularly limited, and for example, the laminate after calcination may be sealed with a resin. Also, an insulator paste having an insulating property such as Al₂O₃ may be applied or dip-coated around the laminate, and the insulator paste may be heat-treated for the sealing.

Further, in the above-described embodiment, a manufacturing method of an all-solid-state secondary battery having a process of forming a side margin layer using the side margin layer paste has been exemplified, but the manufacturing method of an all-solid-state secondary battery according to the present embodiment is not limited to the example. For example, the process of forming the side margin layer using the side margin layer paste may be omitted. The side margin layer may be formed by, for example, deformation of the solid electrolyte layer paste during the manufacturing process of the all-solid-state secondary battery.

While the embodiments according to the present invention have been described in detail above, the present invention is not limited to the above-described embodiments and various modifications can be made.

### EXAMPLES

Hereinafter, the present invention will be described in more detail using examples and comparative examples on the basis of the above-described embodiments, but the present invention is not limited to these examples. Further, “parts” denoted in an input amount of a material in preparing a paste means “parts by mass” unless otherwise specified.

### Example 1

### Manufacture of Positive Electrode Active Material and Negative Electrode Active Material

A positive electrode active material and a negative electrode active material were prepared by the following procedure. Using Li₂CO₃, V₂O₅, and NH₄H₂PO₄ as starting materials, wet-mixing was performed with a ball mill for 16 hours, and this mixed one was dehydrated and dried. The obtained powder was calcined at 850° C. for two hours in a nitrogen-hydrogen mixed gas, wet-pulverized with the ball mill for 16 hours again after the calcination, and finally dehydrated and dried to obtain powders of the positive electrode active material and the negative electrode active material.

As a result of X-ray diffraction (XRD) measurement and inductively coupled plasma (ICP) emission spectroscopy analysis for the obtained active material, it was ascertained to be vanadium lithium phosphate of Li₃V₂(PO₄)₃. Further, in identification of an X-ray diffraction pattern thereof, JCPDS card 74-3236: Li₃V₂(PO₄)₃ was referred to.

### (Preparation of Positive Electrode Active Material Paste and Negative Electrode Active Material Paste)

A positive electrode active material paste and a negative electrode active material paste were prepared by adding 15 parts of ethyl cellulose as a binder and 65 parts of dihydroterpineol as a solvent to 100 parts of powders of the positive electrode active material and the negative electrode active material that have been obtained together, and mixing and dispersing them.

### (Preparation of Solid Electrolyte Paste)

A solid electrolyte was made by the following procedure. Using Li₂CO₃ (lithium carbonate), TiO₂ (titanium oxide), Al₂O₃ (aluminum oxide), and NH₄H₂PO₄ (ammonium dihydrogen phosphate) as starting materials, each material was weighed so that a molar ratio of Li, Al, Ti, and PO₄ was 1.3:0.3:1.7:3.0 (=Li:Al:Ti:PO₄). These were wet-mixed with a ball mill for 16 hours and then dehydrated and dried. The obtained powder was calcined at 800° C. for two hours in the atmosphere, wet-pulverized with the ball mill again for 16 hours again after the calcination, and finally dehydrated and dried to obtain a powder of the solid electrolyte.

As a result of analyzing the obtained powder of the solid electrolyte with an XRD device and an ICP emission spectroscope, it was ascertained to be Li_{1.3}Al_{0.3}Ti_{1.7}(PO₄)₃ (aluminum titanium lithium phosphate) having a NaSICON-type crystal structure. Further, in identification of an X-ray diffraction pattern thereof, JCPDS card 35-0754: LiTi₂(PO₄)₃ was referred to.

100 parts of ethanol and 200 parts of toluene as solvents were added to 100 parts of the powder of the solid electrolyte, and this was wet-mixed with a ball mill. Thereafter, 16 parts of a polyvinyl butyral-based binder and 4.8 parts of benzyl butyl phthalate were added and then wet-mixed with a ball mill to prepare a solid electrolyte paste.

### (Manufacture of Solid Electrolyte Layer Sheet)

Six sheets of the first outer solid electrolyte layers and the second outer solid electrolyte layers were made as the thick-film outer solid electrolyte layer by applying the solid electrolyte paste onto a PET film using a doctor blade-type sheet molding machine. At this time, one of the sheets of the first outer solid electrolyte layer and one of the sheets of the second outer solid electrolyte layer, which were each disposed on a farthest end portion side, were made to have a thickness of 17 μm when a laminate chip to be described later was formed. Also, one of the sheets of the first outer solid electrolyte layer and one of the sheets of the second outer solid electrolyte layer, which were each disposed inward thereof, were made to have a thickness of 11 μm when the laminate chip was formed. Also, one of the sheets of the first outer solid electrolyte layer and one of the sheets of the second outer solid electrolyte layer, which were each disposed further inward from the solid electrolyte layers each disposed inward thereof, were made to have a thickness of 8 μm when the laminate chip was formed. Further, 25 sheets of the inner solid electrolyte layer were made to have a thickness of 5 μm when the laminate chip was formed.

### (Preparation of Positive Electrode Current Collector Paste and Negative Electrode Current Collector Paste)

As a positive electrode current collector and a negative electrode current collector, Cu powder and the prepared powders of the positive electrode active material and the negative electrode active material were mixed to have a volume ratio of 80/20, thereafter 10 parts of ethyl cellulose as a binder and 50 parts of dihydroterpineol as a solvent were added to 100 parts of the mixture, and mixed and dispersed to make a positive electrode current collector layer paste and a negative electrode current collector layer paste.

### (Preparation of Outer Electrode Paste)

Cu powder, an epoxy resin, and a solvent were mixed and dispersed with a ball mill to prepare an outer electrode paste of a thermosetting type.

Using the sheet of the first outer solid electrolyte layer, the sheet of the second outer solid electrolyte layer, the sheet of the inner solid electrolyte layer, the positive electrode current collector paste, the negative electrode current collector paste, and the outer electrode paste, an all-solid-state secondary battery was made by the following procedure.

### (Manufacture of Positive Electrode Unit)

A positive electrode active material layer with a thickness of 5 μm was printed and formed on a portion of a main surface of the sheet of the first outer solid electrolyte layer using a screen printer, and dried at 80° C. for 10 minutes. A positive electrode current collector layer with a thickness of 5 μm was printed and formed on the positive electrode active material layer using a screen printer, and dried at 80° C. for 10 minutes. Further, a positive electrode active material layer with a thickness of 5 μm was printed and formed on the positive electrode current collector layer using a screen printer and dried at 80° C. for 10 minutes, and thereby a positive electrode layer in which the positive electrode current collector layer was sandwiched between the positive electrode active material layers was formed on a portion of the main surface of the sheet of the first outer solid electrolyte layer. Next, a solid electrolyte layer (side margin layer) having substantially the same height as the positive electrode layer was printed and formed on the main surface of the sheet of the first outer solid electrolyte layer in which the positive electrode layer was not printed and formed, and dried at 80° C. for 10 minutes. Next, when a PET film was peeled off, a positive electrode unit in which the positive electrode layer and the solid electrolyte layer were printed and formed on the main surface of the first outer solid electrolyte layer was made.

Similarly, a positive electrode unit in which the positive electrode layer and the solid electrolyte layer were printed and formed on main surfaces of the second outer solid electrolyte layer and the inner solid electrolyte layer was made.

### (Manufacture of Negative Electrode Unit)

A negative electrode unit was made by the same procedure as the positive electrode unit.

(Manufacture of all-Solid-State Secondary Battery)

The positive electrode unit and the negative electrode unit were laminated with one end of the positive electrode layer and one end of the negative electrode layer shifted from each other. At this time, the positive electrode unit and the negative electrode unit were alternately laminated in order so that the first and second outer solid electrolyte layers having a thickness of 17 μm were disposed at a first layer as a lowermost layer and a 31st layer as an uppermost layer when the solid electrolyte layers were counted in order in the lamination direction, the first and second outer solid electrolyte layers having a thickness of 11 μm were disposed at a second layer and a 30th layer, the first and second outer solid electrolyte layers having a thickness of 8 μm were disposed at a third layer and a 29th layer, and the inner solid electrolyte layer having a thickness of 5 μm was disposed at a fourth to 28th layers. Thereby, a laminated substrate formed of a total of 31 solid electrolyte layers including three second outer solid electrolyte layers/25 inner solid electrolyte layers/three first outer solid electrolyte layers aligned in that order in the lamination direction was made.

A plurality of sheets of the inner solid electrolyte layer were laminated on an upper surface and a lower surface of the laminated substrate to provide outer layers formed of the solid electrolyte layers respectively. Further, the outer layers provided on the upper surface and the lower surface were formed to have the same thickness.

Laminated chips were made by cutting the laminated substrate after it was thermocompression-bonded by a die press to enhance adhesion at each laminated interface. Next, the laminated chips were placed on a ceramic setter and retained at 600° C. for two hours in a nitrogen atmosphere for debinding. Next, the laminated chips were calcined by being held at 750° C. for two hours in a nitrogen atmosphere and were taken out after natural cooling.

### (Outer Electrode Forming Step)

An outer electrode paste of Cu was applied to an end surface of the laminated chip after the calcination, then was retained at 150° C. for 30 minutes to be thermally cured to form an outer electrode, and thereby an all-solid-state secondary battery according to example 1 was made.

### (Evaluation of Thickness of Solid Electrolyte Layer)

A thickness tₐ of the inner solid electrolyte layer and a thickness t_{b} (t_{b1}, t_{b2}, t_{b3}, t_{b1}, t_{b2′}, t_{b3′}) of the first and second outer solid electrolyte layers of the all-solid-state secondary battery according to example 1 were calculated by an image analysis after a laminated cross-sectional image of the all-solid-state secondary battery was acquired by a field emission scanning electron microscope (FE-SEM). The laminated cross-sectional image was captured continuously in a vertical direction at a central portion of the all-solid-state secondary battery at a magnification of 700 times to capture the entire laminated portion. Further, a straight line perpendicular to the positive electrode active material layer 1B or the negative electrode active material layer 2B positioned at an end in the lamination direction was drawn in a center of the laminated cross-sectional image, and on the straight line, a length between the positive electrode active material layer 1B and the negative electrode active material layer 2B adjacent to each other was defined as a thickness of the solid electrolyte layer sandwiched between the positive electrode active material layer 1B and the negative electrode active material layer 2B adjacent to each other. In the present embodiment, the thickness of the solid electrolyte layer refers to a thickness of the solid electrolyte layer at a center of the laminate 10 in a width direction. Here, the width direction of the laminate is a direction in which the laminate 10 is sandwiched between the outer positive electrode 60 and the outer negative electrode 70, and refers to an x direction in FIG. 3. As a result of measuring the thickness, the first and 31st layers each had a thickness of 17 μm, the second and 30th layers each had a thickness of 11 μm, the third and 29th layers each had a thickness of 8 μm, and the fourth to 28th layers each had a thickness of 5 μm.

A ratio between a thickness of the outer solid electrolyte layer on the farthest end portion side and a thickness of the outer solid electrolyte layer on an inward side thereof was 1.5 times (17 μm/11 μm), a ratio of thicknesses between adjacent outer solid electrolyte layers inward therefrom was about 1.4 times (11 μm/8 μm), and a ratio of thicknesses between adjacent outer solid electrolyte layer and inner solid electrolyte layer further inward therefrom was 1.6 times (8 μm/5 μm).

### Comparative Example 1

An all-solid-state secondary battery according to comparative example 1 differs from that of example 1 in that 31 solid electrolyte layers all have the same thickness of 5 μm. That is, the all-solid-state secondary battery according to comparative example 1 does not have a thick-film outer solid electrolyte layer.

### Example 2

An all-solid-state secondary battery according to example 2 differs from that of example 1 in that first and 31st layers each have a thickness of 9 μm, second and 30th layers each have a thickness of 7 μm, and third and 29th layers each have a thickness of 6 μm.

In the all-solid-state secondary battery according to example 2, a ratio between a thickness of the outer solid electrolyte layer on the farthest end portion side and a thickness of the outer solid electrolyte layer on an inward side thereof was about 1.3 times (9 μm/7 μm), a ratio of thicknesses between adjacent outer solid electrolyte layers inward therefrom was about 1.2 times (7 μm/6 μm), and a ratio of thicknesses between adjacent outer solid electrolyte layer and inner solid electrolyte layer further inward therefrom was 1.2 times (6 μm/5 μm).

### Example 3

An all-solid-state secondary battery according to example 3 differs from that of example 1 in that first and 31st layers each have a thickness of 13 μm, second and 30th layers each have a thickness of 12 μm, and third and 29th layers each have a thickness of 11 μm.

In the all-solid-state secondary battery according to example 3, a ratio between a thickness of the outer solid electrolyte layer on the farthest end portion side and a thickness of the outer solid electrolyte layer on an inward side thereof was about 1.1 times (13 μm/12 μm), a ratio of thicknesses between adjacent outer solid electrolyte layers inward therefrom was about 1.1 times (12 μm/11 μm), and a ratio of thicknesses between adjacent outer solid electrolyte layer and inner solid electrolyte layer further inward therefrom was 2.2 times (11 μm/5 μm).

### Example 4

The all-solid-state secondary battery according to example 4 differs from that of example 1 in that first to third layers and 29th to 31st layers all have a thickness of 6 μm.

In the all-solid-state secondary battery according to example 4, a ratio between a thickness of the outer solid electrolyte layer on the farthest end portion side and a thickness of the outer solid electrolyte layer on an inward side thereof was one times (6 μm/6 μm), a ratio of thicknesses between adjacent outer solid electrolyte layers inward therefrom was one times (6 μm/6 μm), and a ratio of thicknesses between adjacent outer solid electrolyte layer and inner solid electrolyte layer further inward therefrom was 1.2 times (6 μm/5 μm).

### Example 5

An all-solid-state secondary battery according to example 5 differs from that of example 1 in that the first and second outer solid electrolyte layers as the thick-film outer solid electrolyte layer are each formed of two layers, first and 31st layers each have a thickness of 11 μm, and second and 30th layers each have a thickness of 8 μm.

In the all-solid-state secondary battery according to Example 5, a ratio between a thickness of the outer solid electrolyte layer on the farthest end portion side and a thickness of the outer solid electrolyte layer on an inward side thereof was about 1.4 times (11 μm/8 μm), and a ratio of thicknesses between adjacent outer solid electrolyte layer and inner solid electrolyte layer disposed further inside thereof was 1.6 times (8 μm/5 μm).

### Example 6

An all-solid-state secondary battery according to example 6 differs from that of example 1 in that the first and second outer solid electrolyte layers as the thick-film outer solid electrolyte layer are each formed of two layers, first and 31st layers each have a thickness of 12 μm, and second and 30th layers each have a thickness of 11 μm.

In the all-solid-state secondary battery according to Example 6, a ratio between a thickness of the outer solid electrolyte layer on the farthest end portion side and a thickness of the outer solid electrolyte layer on an inward side thereof was about 1.1 times (12 μm/11 μm), and a ratio of thicknesses between adjacent outer solid electrolyte layer and inner solid electrolyte layer disposed further inside thereof was 2.2 times (11 μm/5 μm).

### Example 7

An all-solid-state secondary battery according to example 7 differs from that of example 1 in that the first and second outer solid electrolyte layers as the thick-film outer solid electrolyte layer are each formed of one layer, and first and 31st layers each have a thickness of 15 μm.

In the all-solid-state secondary battery according to example 7, a ratio between a thickness of the outer solid electrolyte layer on the farthest end portion side and a thickness of the inner solid electrolyte layer was three times (15 μm/5 μm).

### Example 8

An all-solid-state secondary battery according to example 8 differs from that of example 1 in that only the first outer solid electrolyte layer is provided as the thick-film outer solid electrolyte layer, the first outer solid electrolyte layer is formed of three layers, a 31st layer has a thickness of 17 μm, a 30th layer has a thickness of 11 μm, and a 29th layer has a thickness of 8 μm.

A ratio between a thickness of the outer solid electrolyte layer on the farthest end portion side and a thickness of the outer solid electrolyte layer on an inward side thereof was 1.5 times (17 μm/11 μm), a ratio of thicknesses between adjacent outer solid electrolyte layers inward therefrom was about 1.4 times (11 μm/8 μm), and a ratio of thicknesses between adjacent outer solid electrolyte layer and inner solid electrolyte layer further inward therefrom was 1.6 times (8 μm/5 μm).

### Example 9

An all-solid-state secondary battery according to example 9 differs from that of example 1 in that only the first outer solid electrolyte layer is provided as the thick-film outer solid electrolyte layer, the first outer solid electrolyte layer is formed of one layer, and a 31st layer has a thickness of 15 μm.

In the all-solid-state secondary battery according to example 9, a ratio between a thickness of the outer solid electrolyte layer on the farthest end portion side and a thickness of the inner solid electrolyte layer was three times (15 μm/5 μm).

### (Battery Evaluation)

The all-solid-state secondary batteries made in the present examples and comparative examples can be evaluated for the following battery characteristics.

### [Short-Circuit Resistance Test]

An outer negative terminal and an outer positive terminal of the all-solid-state secondary battery made in each of the present examples and comparative examples were clamped with measurement probes, and charging and discharging were repeated under, for example, charging/discharging conditions illustrated below.

In an environment of 25° C., constant-current charging (CC charging) was performed until a battery voltage reached 1.6 V at a constant current of 1 C rate, and then the battery was discharged (CC discharging) until the battery voltage reached 0 V at a constant current of 1 C rate. The charging and discharging described above were defined as one cycle, and an incidence of short circuit was obtained from the number of short-circuited all-solid secondary batteries out of 100 all-solid secondary batteries that have been subjected to repeating the cycle up to 1000 cycles. A case in which a voltage dropped sharply and then did not rise during CC charging was determined to be a short circuit.

### (Result)

Table 1 shows results of the short-circuit resistance test for the all-solid secondary batteries according to examples 1 to 9 and comparative example 1.

TABLE 1

| | | | | First outer solid | | | | | Second outer solid | | | | | Incidence |
|---|---|---|---|---|---|---|---|---|---|---|---|---|---|---|
| | Total | Inner solid | | electrolyte layer | | | | | electrolyte layer | | | | | of short |
| | number | electrolyte layer | | | Number | Thickness | | | | Number | Thickness | | | circuit at |
| | of | | Thickness | | of | t_{b} [μm] | | | | of | t_{b'} [μm] | | | 1000 |
| | layers | Composition | tₐ (μm) | Composition | layers | t_{b1} | t_{b2} | t_{b3} | Composition | layers | t_{b1'} | t_{b2'} | t_{b3'} | cycles |
| Example 1 | 31 | LATP | 5 | LATP | 3 | 17 | 11 | 8 | LATP | 3 | 17 | 11 | 8 | 2 |
| Example 2 | 31 | LATP | 5 | LATP | 3 | 9 | 7 | 6 | LATP | 3 | 9 | 7 | 6 | 3 |
| Example 3 | 31 | LATP | 5 | LATP | 3 | 13 | 12 | 11 | LATP | 3 | 13 | 12 | 11 | 5 |
| Example 4 | 31 | LATP | 5 | LATP | 3 | 6 | 6 | 6 | LATP | 3 | 6 | 6 | 6 | 5 |
| Example 5 | 31 | LATP | 5 | LATP | 2 | 11 | 8 | — | LATP | 2 | 11 | 8 | — | 5 |
| Example 6 | 31 | LATP | 5 | LATP | 2 | 12 | 11 | — | LATP | 2 | 12 | 11 | — | 6 |
| Example 7 | 31 | LATP | 5 | LATP | 1 | 15 | — | — | LATP | 1 | 15 | | — | 7 |
| Example 8 | 31 | LATP | 5 | LATP | 3 | 17 | 11 | 8 | LATP | 0 | — | — | — | 7 |
| Example 9 | 31 | LATP | 5 | LATP | 1 | 15 | — | — | LATP | 0 | — | — | — | 8 |
| Comparative | 31 | LATP | 5 | LATP | 0 | — | — | | LATP | 0 | — | — | — | 15 |
| example 1 | | | | | | | | | | | | | | |

Based on Table 1, in all cases of examples 1 to 9, the incidence of short circuit was lower than that of comparative example 1, and the short-circuit resistance was higher.

In the all-solid-state secondary battery according to example 1 in which three thick-film outer solid electrolyte layers were symmetrically provided at both end portions of the laminate and the ratio of thicknesses toward the end portions was about 1.5 times, the incidence of short circuit was 2%, exhibiting a highest short-circuit resistance.

Also, in the all-solid-state secondary according to example 2 in which three thick-film outer solid electrolyte layers were symmetrically provided at both end portions of the laminate and the ratio of thicknesses toward the end portions was about 1.2 times, the incidence of short circuit was 3%, exhibiting a second highest short-circuit resistance.

Examples 3 and 4 in which three thick-film outer solid electrolyte layers were symmetrically provided at both end portions of the laminate had the incidence of short circuit of 5%, which was the same as the incidence of short circuit of example 5 in which two thick-film outer solid electrolyte layers were symmetrically provided at both end portions of the laminate, but exhibited a higher short-circuit resistance than the short-circuit resistance of example 6 in which two layers were symmetrically provided at both end portions in the same manner. Also, the incidences of short circuit of examples 3 and 4 were lower than the incidence of short circuit of example 7 in which one thick-film outer solid electrolyte layer was symmetrically provided at both end portions of the laminate, and the incidences of short circuit of examples 5 and 6 were lower than the incidence of short circuit of example 7.

Based on the results of the short-circuit resistance tests of examples 1 to 7, in a configuration in which the thick-film outer solid electrolyte layer is symmetrically provided at both end portions of the laminate, the short-circuit resistance is higher in descending order of the number of layers (in order of three layers, two layers, and one layer). Also, based on the results of the short-circuit resistance tests of examples 8 and 9, also in a configuration in which the thick-film outer solid electrolyte layer is provided at one end portion of the laminate, the short-circuit resistance is higher in descending order of the number of layers (in order of three layers and one layer).

Example 8 in which three thick-film outer solid electrolyte layers were provided at one end portion of the laminate and example 7 in which one thick-film outer solid electrolyte layer was symmetrically provided at both end portions of the laminate exhibited the same short-circuit resistance.

### Examples 10 to 18

In all-solid-state secondary batteries according to examples 10 to 18, all-solid-state secondary batteries were made in the same procedure as in example 1 except that a solid electrolyte material of any of the first and second outer solid electrolyte layers and the inner solid electrolyte layer, or all solid electrolyte materials of them were changed to a material other than LATP, and battery evaluations thereof were performed in the same procedure as in example 1.

### Example 10

In the all-solid-state secondary battery according to example 10, an all-solid-state secondary battery was made in the same procedure as in example 1 except that solid electrolyte materials of all the first and second outer solid electrolyte layers and inner solid electrolyte layer were changed to LZP (LiZr₂(PO₄)₃), and a battery evaluation thereof was performed in the same procedure as in example 1. The solid electrolyte of LZP was made by the following synthesis method.

LZP was made by the same synthesis method as in example 1 by using Li₂CO₃ (lithium carbonate), ZrO₂ (zirconium oxide), and NH₄H₂PO₄ (ammonium dihydrogen phosphate) as starting materials, and weighing a molar ratio of Li, Zr, and PO₄ to be 1:2:3 (=Li:Zr:PO₄). It was ascertained from XRD measurement and an ICP analysis that the obtained solid electrolyte was LiZr₂(PO₄)₃.

### Example 11

In the all-solid-state secondary battery according to example 11, an all-solid-state secondary battery was made in the same procedure as in example 1 except that solid electrolyte materials of all the first and second outer solid electrolyte layers and inner solid electrolyte layer were changed to LLZ (Li₇La₃Zr₂O₁₂), and a battery evaluation thereof was performed in the same procedure as in example 1. The solid electrolyte of LLZ was made by the following synthesis method.

LLZ was made by the same synthesis method as in example 1 by using Li₂CO₃ (lithium carbonate), La₂O₃ (lanthanum oxide), and ZrO₂ (zirconium oxide) as starting materials, and weighing a molar ratio of Li, La, and Zr to be 7:3:2 (=Li:La:Zr). It was ascertained from XRD measurement and an ICP analysis that the obtained solid electrolyte was Li₇La₃Zr₂O₁₂.

### Example 12

In the all-solid-state secondary battery according to example 12, an all-solid-state secondary battery was made in the same procedure as in example 1 except that solid electrolyte materials of all the first and second outer solid electrolyte layers and inner solid electrolyte layer were changed to LLTO (Li_{0.3}La_{0.55}TiO₃), and a battery evaluation thereof was performed in the same procedure as in example 1. The solid electrolyte of LLTO was made by the following synthesis method. LLTO was made by the same synthesis method as in example 1 by using Li₂CO₃ (lithium carbonate), La₂O₃ (lanthanum oxide), and TiO₂ (titanium oxide) as starting materials, and weighing a molar ratio of Li, La, and Ti to be 0.3:0.55:1.0 (=Li:La:Ti). It was ascertained from XRD measurement and an ICP analysis that the obtained solid electrolyte was Li_{0.3}La_{0.55}TiO₃.

### Example 13

In the all-solid-state secondary battery according to example 13, an all-solid-state secondary battery was made in the same procedure as in example 1 except that solid electrolyte materials of all the first and second outer solid electrolyte layers and inner solid electrolyte layer were changed to LSPO (Li_{3.5}Si_{0.5}P_{0.5}O₄), and a battery evaluation thereof was performed in the same procedure as in example 1. The solid electrolyte of LSPO was made by the following synthesis method.

LSPO was made using Li₂CO₃, SiO₂, and commercially available Li₃PO₄ as starting materials, weighing them so that a molar ratio was 2:1:1, wet-mixing them with water as a dispersion medium by a ball mill for 16 hours, and then dehydrating and drying them. The obtained powder was calcined at 950° C. for two hours in the atmosphere, wet pulverized with the ball mill for 16 hours again, and finally dehydrated and dried to obtain a powder of the solid electrolyte. It was ascertained from the results of XRD measurement and an ICP analysis that the above-described powder was Li_{3.5}Si_{0.5}P_{0.5}O₄ (LSPO).

### Examples 14 to 18

In all-solid-state secondary batteries according to examples 14 to 18, all-solid-state secondary batteries were made in the same procedure as in example 1 except that solid electrolyte materials of the first and second outer solid electrolyte layers were changed to a material other than LATP while a solid electrolyte material of the inner solid electrolyte layer was LATP, and battery evaluations thereof were performed in the same procedure as in example 1.

### Example 14

In the all-solid-state secondary battery according to example 14, an all-solid-state secondary battery was made in the same procedure as in example 1 except that solid electrolyte materials of the first and second outer solid electrolyte layers were changed to LTP, and a battery evaluation thereof was performed in the same procedure as in example 1.

LTP was made by the same synthesis method as in example 1 by using Li₂CO₃ (lithium carbonate), TiO₂ (titanium oxide), and NH₄H₂PO₄ (ammonium dihydrogen phosphate) as starting materials, and weighing each material so that a molar ratio of Li, Ti, and PO₄ was 1.0:2.0:3.0 (=Li:Ti:PO₄). It was ascertained from XRD measurement and an ICP analysis that the obtained solid electrolyte was LiTi₂(PO₄)₃.

### Example 15

In the all-solid-state secondary battery according to example 15, an all-solid-state secondary battery was made in the same procedure as in example 1 except that solid electrolyte materials of the first and second outer solid electrolyte layers were changed to LAGP, and a battery evaluation thereof was performed in the same procedure as in example 1.

LAGP was made by the same synthesis method as in example 1 except that the starting material was changed to GeO₂ instead of TiO₂, and a molar ratio of Li, Al, Ge, and PO₄ was weighed to be 1.3:0.3:1.7:3.0 (=Li:Al:Ge:PO₄). It was ascertained from XRD measurement and an ICP analysis that the obtained solid electrolyte was Li_{1.3}Al_{0.3}Ge_{1.7}(PO₄)₃.

### Example 16

In the all-solid-state secondary battery according to example 16, an all-solid-state secondary battery was made in the same procedure as in example 1 except that solid electrolyte materials of the first and second outer solid electrolyte layers were changed to LYZP, and a battery evaluation thereof was performed in the same procedure as in example 1.

LYZP was made by the same synthesis method as in example 1 by using Li₂CO₃ (lithium carbonate), Y(NO₃)₃ (yttrium nitrate), ZrO(NO₃)_{2.2}H₂O (zirconium oxynitrate), and NH₄H₂PO₄ (ammonium dihydrogen phosphate) as starting materials, and weighing Li, Y, Zr, and PO₄ to have a molar ratio of 1.1:0.1:1.9:3.0 (=Li:Y:Zr:PO₄). It was ascertained from XRD measurement and an ICP analysis that the obtained solid electrolyte was Li_{1.3}Y_{0.3}Zr_{1.7}(PO₄)₃.

### Example 17

In the all-solid-state secondary battery according to example 18, an all-solid-state secondary battery was made in the same procedure as in example 1 except that solid electrolyte materials of the first and second outer solid electrolyte layers were changed to LLZ, and a battery evaluation thereof was performed in the same procedure as in example 1.

### Example 18

In the all-solid-state secondary battery according to example 18, an all-solid-state secondary battery was made in the same procedure as in example 1 except that solid electrolyte materials of the first and second outer solid electrolyte layers were changed to LATP+LGPT, and a battery evaluation thereof was performed in the same procedure as in example 1.

### (Result)

Table 2 shows results of the short-circuit resistance test for the all-solid secondary batteries according to examples 10 to 18. For reference, example 1 was also shown in Table 2.

TABLE 2

| | | | | First outer solid | | | | | Second outer solid | | | | | Incidence |
|---|---|---|---|---|---|---|---|---|---|---|---|---|---|---|
| | Total | Inner solid | | electrolyte layer | | | | | electrolyte layer | | | | | of short |
| | number | electrolyte layer | | | Number | Thickness | | | | Number | Thickness | | | circuit at |
| | of | | Thickness | | of | t_{b} [μm] | | | | of | t_{b'} [μm] | | | 1000 |
| | layers | Composition | tₐ (μm) | Composition | layers | t_{b1} | t_{b2} | t_{b3} | Composition | layers | t_{b1'} | t_{b2'} | t_{b3'} | cycles |
| Example 1 | 31 | LATP | 5 | LATP | 3 | 17 | 11 | 8 | LATP | 3 | 17 | 11 | 8 | 2 |
| Example 10 | 31 | LZP | 5 | LZP | 3 | 17 | 11 | 8 | LZP | 3 | 17 | 11 | 8 | 3 |
| Example 11 | 31 | LLZ | 5 | LLZ | 3 | 17 | 11 | 8 | LLZ | 3 | 17 | 11 | 8 | 3 |
| Example 12 | 31 | LLTO | 5 | LLTO | 3 | 17 | 11 | 8 | LLTO | 3 | 17 | 11 | 8 | 3 |
| Example 13 | 31 | LSPO | 5 | LSPO | 3 | 17 | 11 | 8 | LSPO | 3 | 17 | 11 | 8 | 3 |
| Example 14 | 31 | LATP | 5 | LTP | 3 | 17 | 11 | 8 | LTP | 3 | 17 | 11 | 8 | 5 |
| Example 15 | 31 | LATP | 5 | LAGP | 3 | 17 | 11 | 8 | LAGP | 3 | 17 | 11 | 8 | 5 |
| Example 16 | 31 | LATP | 5 | LYZP | 3 | 17 | 11 | 8 | LYZP | 3 | 17 | 11 | 8 | 5 |
| Example 17 | 31 | LATP | 5 | LLT | 3 | 17 | 11 | 8 | LLT | 3 | 17 | 11 | 8 | 5 |
| Example 18 | 31 | LATP | 5 | LATP + | 3 | 17 | 11 | 8 | LATP + | 3 | 17 | 11 | 8 | 5 |
| | | | | LAGP | | | | | LAGP | | | | | |

Based on Table 2, when solid electrolyte materials of the first and second outer solid electrolyte layers and the inner solid electrolyte layer were all the same, example 1 in which the solid electrolyte material was LATP was most excellent in short-circuit resistance, and in cases (examples 10 to 13) of solid electrolyte materials other than that, the short-circuit resistances were the same as each other.

Also, in cases (examples 14 to 18) in which a solid electrolyte material of the inner solid electrolyte layer was LATP and solid electrolyte materials of the first and second outer solid electrolyte layers were different from LATP, the short-circuit resistances were the same as each other.

When solid electrolyte materials of all the first and second outer solid electrolyte layers and inner solid electrolyte layer were the same, the short-circuit resistance thereof was superior to the cases (examples 14 to 18) in which the solid electrolyte material of the inner solid electrolyte layer was LATP and the solid electrolyte materials of the first and second outer solid electrolyte layers were different from LATP.

Although the present invention has been described in detail above, the above-described embodiments and examples are merely examples, and the invention disclosed herein includes various changes and modifications of the above-described specific examples.

### REFERENCE SIGNS LIST

1 Positive electrode layer
1A Positive electrode current collector
1B Positive electrode active material layer
2 Negative electrode layer
2A Negative electrode current collector
2B Negative electrode active material layer
3 Side margin layer
4 Outer layer
5 Solid electrolyte layer
5A Inner solid electrolyte layer
5B Thick-film outer solid electrolyte layer
5BA First outer solid electrolyte layer
5BB Second outer solid electrolyte layer
10 Laminate
60 Outer positive electrode
70 Outer negative electrode
100, 101 All-solid-state secondary battery

What is claimed is:

1. An all-solid-state secondary battery comprising a laminate which includes a plurality of positive electrode layers each including a positive electrode active material layer, a plurality of negative electrode layers each including a negative electrode active material layer, and a plurality of solid electrolyte layers each containing a solid electrolyte, and in which the positive electrode layers and the negative electrode layers are alternately laminated with the solid electrolyte layers interposed therebetween,
wherein the plurality of solid electrolyte layers includes:
a first outer solid electrolyte layer and a second outer solid electrolyte layer disposed on both end portion sides of the laminate in a lamination direction; and
an inner solid electrolyte layer (with a thickness of tₐ) disposed between the first outer solid electrolyte layer and the second outer solid electrolyte layer, and
at least one outer solid electrolyte layer of the first outer solid electrolyte layer and the second outer solid electrolyte layer is a thick-film outer solid electrolyte layer (with a thickness of t_{bn}(1≤n)>tₐ) having a thickness more than that of the inner solid electrolyte layer.

2. The all-solid-state secondary battery according to claim 1,
wherein the thick-film outer solid electrolyte layer includes a plurality of solid electrolyte layers, and
a layer of the plurality of solid electrolyte layers disposed closer to each of the end portions has a more thickness.

3. The all-solid-state secondary battery according to claim 1,
wherein the thick-film outer solid electrolyte layer includes a plurality of solid electrolyte layers, and
when a thickness of an n-th thick-film outer solid electrolyte layer in the plurality of solid electrolyte layers counted inward from a thick-film outer solid electrolyte layer disposed at the end portion is t_{bn}, the following expression is satisfied.
t_{b(n+1)}≤t_{bn}≤t_{b(n+1)}×2.

4. The all-solid-state secondary battery according to claim 1,
wherein when the number of layers of the thick-film outer solid electrolyte layer is q, the following expression is satisfied.
3≤q

5. The lithium ion secondary battery according to claim 1,
wherein the solid electrolyte has a crystal structure of any one of a NaSICON type, a garnet type, and a perovskite type.
